(19) United States
(12) Patent Application Publication
(10) Pub. No.: US 2010/0181130 A1
(43) Pub. Date: Jul. 22, 2010

(54) Dual-Drivetrain of Power-Assist Vehicle

(76) Inventor: Wen-Cheng Chou, Taoyuan (TW)

Correspondence Address: SHUI-CHOU CHOU, 5032-12 Hunt Club Road, Wilmington, NC, 28403, US

(21) Appl. No.: 12/504,856

(22) Filed: Jul. 17, 2009

(30) Foreign Application Priority Data
Jan. 21, 2009 (TW) 09201110

(51) Int. Cl. B62M 23/02

(52) U.S. Cl. 180/206

(57) ABSTRACT

The creative product relating to a “power bicycle's dual-drive device”, which contains a pedal-driven part, a motor-driven part, a gearing mechanism, and a controller; the electric motor axis of the motor-driven part has a drive-gear and the relay-gear, the first and second transmission member connect the gear plate with the relay-gear and the drive gear with the transmission gear disc respectively, through the dual-drive device, either alone or mixed selection; by the driven pedal to control the electric driven motor and to drive the driven gear for operation, to produce large torque output in order to drive the transmission gear disc, to correspond with the transmission to control the second transmission member to the transmission gear disc of different outside diameters for changing the gear, for satisfying the riders to choice their own mode of laborsaving or exercise demand in different terrains.

### CROSS-REFERENCE TO RELATED APPLICATIONS

This application claims the benefit of Foreign Application of Taiwan, Republic of China (Taiwan New Model Application No. 09201110), filed on Jan. 21, 2009.

### BACKGROUND OF THE INVENTION

1. Field of Invention

This invention relates to a motorized vehicle, specifically related to a dual-drive device (dual-drivetrain) of the motorized vehicle, more specifically related to the dual-drivetrain that simultaneously transmits both electric and pedal driven power so that the vehicle can use an attached motor to assist with pedaling. The dual-drivetrain can be applied to various kinds of pedal-driven, human-powered vehicle, such as bicycles, tandem bicycle, tricycles, as well as mopeds.

2. Description of Related Art

With an increasing awareness of saving energy and minimizing carbon dioxide emission, human-powered and pedal-driven vehicles (e.g., bicycles, tricycles) have become quite popular transportation in the world. In addition to reducing fossil fuel consumption and environmental friendly, pedaling is a good exercise to achieve body's fitness exercise.

At present, the pedal-driven vehicle can be divided into two categories: one is a traditional pedal driven vehicle (e.g., the traditional bicycle); the other is a motorized vehicle (i.e., a motorized bike with an attached motor used to assist with pedaling). Motorized bikes are distinguished from motorcycles by being capable of being powered by pedals alone if required. The actual usage of the pedals varies widely according to the type of vehicle. Those known as mopeds mostly have pedals for emergency use; or because of legal requirements, and these pedals are not normally used. Those known as power-assist bikes have the pedals as the main form of propulsion with the motor used to give a bit of extra speed, especially uphill. The bikes used herein denote to human-powered and pedal-driven vehicles, including and not being limited to bicycles and tandem bicycles; whereas vehicles include and are unlimited to bikes, moped, tricycle and quadracycles. Bike and vehicle may be used convertably in the present invention.

Power-assist vehicle is usually powered by electric motors or small internal combustion engines. With lighter batteries and better storage density, the electric motor has recently seen an increase in popularity. Currently, the electric motor can be installed nearby the front or rear wheel for powering the wheel independent of pedaling, or the motor can be installed in the vehicle frame for powering the wheel via a pedal-drivetrain (which can be a roller chain in most bikes or a driveshaft in others). When the electric motor propels the drivetrain, the pedal will rotate accordingly. If the vehicle is not properly operated under constant attention, rider may easily be injured.

In order to avoid pedal rotating with drivetrain and injuring the rider, various methods have been disclosed, for example, Taiwan Patents Notice No. 1296597, M328416, etc. Although these methods could effectively reduce rider's injury, their motor-assist drivetrain cannot perform multi-gear change. Accordingly, the riders lose fun of variable-speed riding when riding such kind of power-assisted vehicle. The inventor has positively devoted his experiences and efforts to study and develop the present invention “Dual-Drivetrain of Power-Assist Vehicle”, and put the invention into manufacture.

### BRIEF SUMMARY OF THE INVENTION

The present invention is drawn to a dual-drivetrain for powering a vehicle by pedaling with an assistance of an attached motor. It comprises a pedal-driven part, a motor-driven part, a transmission member, and a controller. Several objects and advantage to the present invention are: (1) to provide a dual-drivetrain that can propelled a vehicle with both motor- and pedal-driven power; (2) to provide a dual-drivetrain that perform multiple-gear change, thus enhance uphill momentum; (3) to provide a dual-drivetrain that has simple structure, thus easily be manufactured and maintained. Still further objects and advantages of present invention will become apparent from a consideration of the drawings and ensuing description.

### BRIEF DESCRIPTION OF SEVERAL VIEWS OF THE DRAWINGS

FIG. 1 is a schematic view of the present invention applied in the vehicle's frame.

FIG. 2 is an elevational view of a pedal-driven part and a motor-driven part.

FIG. 3 is an isometric view of the motor-driven part.

FIG. 4 is an elevational view of the motor-driven part and power conveying means.

FIG. 5 is an elevation view of the dual-drivetrain of the present invention as illustrated in FIG. 1.

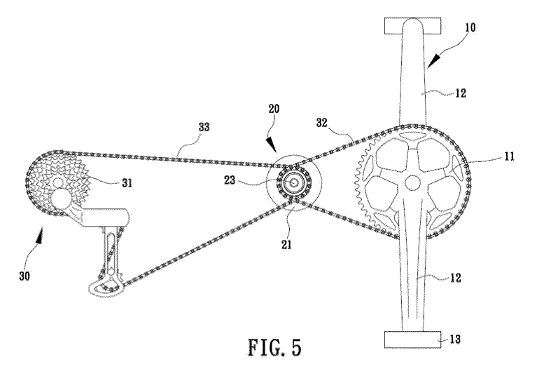

FIG. 6 is a schematic diagram of the state of transmission.

### REFERENCE NUMERALS IN DRAWINGS

10 Pedal-driven part

11 Gear plate

12 Crank

13 Pedal

20 Motor-driven part

21 Electric motor

22 Drive-gear

23 Relay-gear

30 Gearing mechanism

31 Transmission gear disc

32 First transmission member

33 Second transmission member

50 Frame

51 Rear wheel

### DETAILED DESCRIPTION OF THE INVENTION

### (1) The Preferred Embodiments

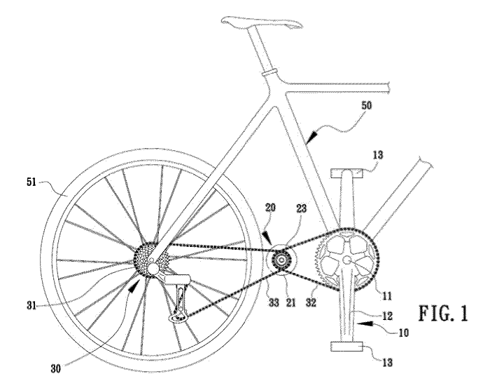

The present invention provides a dual-drivetrain for powering a vehicle by pedaling with an assistance of an attached motor (FIG. 1). It comprises a pedal-driven part 10, a motor-driven part 20, power conveying means, and a controller.

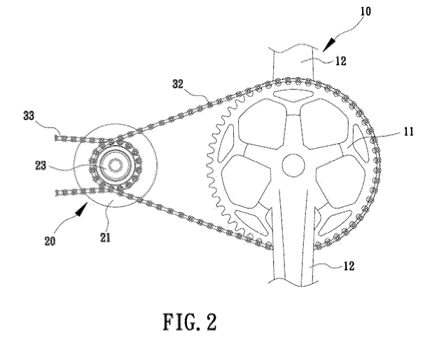

Pedal-driven part 10, also known as a crankset in a traditional bicycle, is pivotally mounted to a frame 50 of the vehicle (FIG. 1). With reference to FIGS. 2 & 5, it has at least one gear plate 11 (also called chainwheels or front gears), a pair of cranks 12 normally mounted 180 degree out of phase to gear plate 11, and a pair of pedals 13 pivotally attached to each crank 12.

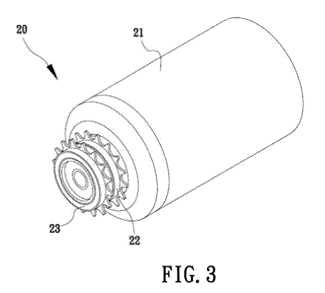

Motor-driven part 20 is also firmly attached to frame 50, situated preferably between pedal-driven part 10 and a real wheel 51 (FIGS. 1 & 2). As illustrated in FIG. 3, motor-driven part 20 has an electric motor 21, a drive-gear 22, and a relay-gear 23. Both drive gear 22 and relay gear 23 are pivotally attached to the armature of electric motor 21. While drive-gear 22 can rotate either clockwise or counterclockwise, relay-gear 23 rotates only clockwise. These have been disclosed previously by Inventor (Taiwan New Model Patent Notice No. 397023) and will not be addressed in detail here. While drive-gear 22 mechanically couples real wheel 51, relay-gear 23 couples pedal-driven part 10. See supra.

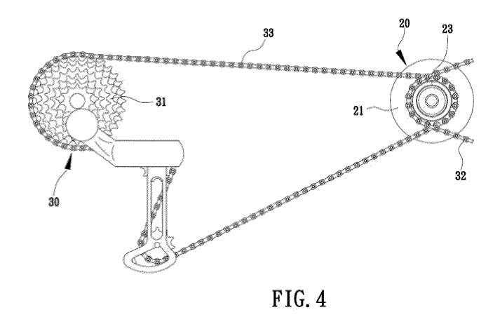

The power conveying part comprises a first transmission member 32 and a gearing mechanism 30 (FIGS. 4 & 5). First transmission member 32 can be as simple as a roller chain (FIGS. 2 & 3) that couples gear plate 11 and relay-gear 23, resulting in a synchronized rotation of relay-gear 23 with pedal-driven part 10.

Gearing mechanism 30 is a variable-ratio transmission system for selecting appropriate gear ratios for optimum efficiency or comfort while riding a bike. It can be a derailleur mechanism or an internal hub gear mechanism. As illustrated in FIGS. 4 & 5, the preferred gearing mechanism of the present invention is the derailleur mechanism that includes second transmission member 33, a transmission gear disc 31, and a rear derailleur (reference numeral not shown). Transmission gear disc 31 is a set of multiple rear-gears that has various diameters (FIGS. 4 & 5) and concentrically attaches to real wheel 51 (FIG. 1). Second transmission member 33 can be simply a roller chain that rotationally couples one of rear-gears (i.e., transmission gear disc 31), the rear derailleur and relay-gear 22 (i.e., motor-driven part 20) (FIGS. 4 & 5). The rear derailleur mechanism is a well-known gearing mechanism of the art of bicycle; thereby it will not addressed here in detail.

The controller (not shown in Figures) can be is mounted on the any predetermined position of frame 50 (e.g., on the down tube of the frame, on the handlebars or at the ends of triathlon bars). It includes a regulator and a shifter. See infra.

The shifter is used for remotely operating gearing mechanism 30 by various well-known methods. For example, many modern bicycles utilize a cable, (e.g. a Bowden cable) for mechanically lining the shifter to the rear-derailleur (chain-guide) of the gearing mechanism. When a rider operates the lever of the shifter while pedaling, the change in cable tension moves the chain-guide from side to side, “derailing” the chain (i.e, second transmission member 23) onto different gears of Transmission gear disc 31.

The regulator, which electrically couples a battery (no shown in Figures) and electric motor 21, is used for remotely regulating the rotational speed of electric motor 21. Depending of the type of electric motor 21, various devices are known to control motor's speed. For example, generally, the speed of a DC motor is proportional to the voltage applied to it, and the torque is proportional to the current. Speed control can be achieved by variable sbattery tappings, variable supply voltage, resistors, or electronic controls. Pulse-width modulation (PWM) is the preffered method for controlling the speed of electric motor 21, and TL494 is the preferred electronic chip, which provides PWM power-control circuit.

The regulator preferably further comprises a sensor that provides a feedback loop for adjusting rotor's speed based on vehicle's speed. It electrically couples a vehicle's speed monitor and provides feedback signal to the regulator for adjusting motor's speed based on vehicle's speed. This kind of feedback loop electronic device is well-known to one skilled in the art.

### (2) The Best Mode of Carrying Out the Invention

While pedalling, relay-gear 23 is synchronized with gear plate 11; the synchronization is detected by a monitor mounted in a predetermined position of frame 50. The monitor sends signals to the sensor, which is electronically couples to the regulator that regulates electric motor 21. Electric motor 21 rotates relay-gear 23 and produces torque output, so that raider can save labor/energy of pedalling.

Not only pedalling activates electric motor 21, but also it regulates and adjusts the speed of electric motor 21 via feedback signals from the sensor to the regulator. While the pre-determined speed of vehicle is reaching, the feedback signal stops electric motor 21 from running; relay-sprocking 23 becomes gear idling, almost without resistance. Accordingly, the armature of electric motor 21 is not rotating, is protected from wearing out, thus elongate the lifetime of electric motor 21. While the speed is not reaching, the feedback signal protentiates electric motor 21 to run and kick in extra speed. Moreover, the controller further includes the shifter. Operating the shifter, riders can cruise all terrains by their choice of gears (i.e., speed vs. torque ration).

Referring to FIGS. 3 &5, besides pedaling, riders can directly use the controller to activate electric motor 21 for running drive-gear 22, and use second transmission member 33 to rotate transmission gear disc 31 for driving wheel 51. Here, gear plate 11 does not rotate by pedaling, relay-gear 23 keeps idle, and thus wheel 51 is powered by electric motor 21 (i.e., electro drive mode). In the electro drive mode, riders can also operate the shifter to “derail” to various gears and enjoy multiple gear-speed effect.

Additionally, when electric motor 21 is shut down, riders will use pedals directly to lead relay-gear 23 and drive-gear 22 to operate, and then through second transmission member 33 to run transmission gear disc 31, whereby wheel 51 is rotated with pedaling (i.e., pedal drive mode). Still, in the pedal drive mode, riders can operate the shifter to “derail” to various gears and enjoy multiple gear-speed effect.

While pedaling, the sensor signals feed back to regulator; that in turn regulates electric motor 21 and rotates drive-gear 22, whereby a huge torque output is produced. The torque enables drive-gear 22 and relay-gear 23 to produce the synchronous operation; whereby wheel 51 is powered by both pedaling and electric motor 21 (i.e., dual mixed mode). Still, in the dual mixed mode, riders can operate the shifter to “derail” to various gears, enjoy multiple gear-speed effect and enhance uphill climbing ability.

It is worth mentioning that when relay-gear 23 is operated by Gear plate 11, drive-gear 22 is running with relay-gear 23. Only at this moment, electric motor 21 keeps the status without function (i.e., the armature of electric motor 21 dose not rotated with drive-gear 22), so that it can reach the effects of protecting electric motor 21. Thus, motor-driven part 20 has been disclosed by thee original inventor (Taiwan New Model Patent Notice No. 397023 where its second wheel chain is equivalent to the drive-gear 22 of FIG. 3, and where its one-way rotation component is equivalent to relay-gear 23.

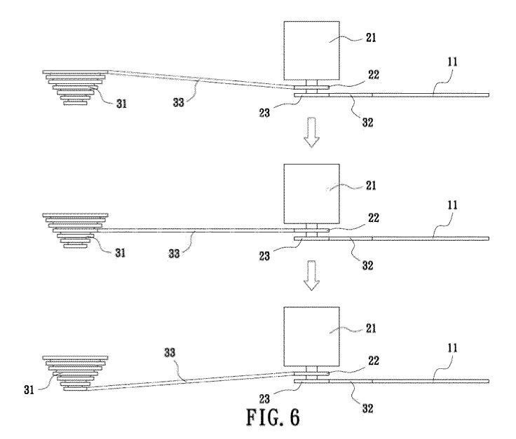

Finally, please refer to FIG. 6 that is a schematic diagram of the state of transmission of this invention. The present invention approaches the electric and pedal output of duel driven effects mainly through the motion of electric motor 21 and gear plate 11: namely, when drive-gear 22 operates, the settings of relay-gear 23 can produce gear idling, almost without resistance; the gear idling protects electric motor 21 and extends the service life of electric motor 21. Because transmission gear disc 31 is formed by a plurality of rear-gears of various diameters, regardless pedal-driven or electric-driven, riders can operate on the shifter of the controller for controlling gearing mechanism 30 so that second transmission member 33 will couple drive-gear 22 to one of the rear-gears accordingly, whereby suitable speed-torque ratio can be achieved. The riders can enjoy multiple gearing (speed-to-torque ratio) while riding in various kinds of terrains and exercising by their own choice (pedal-, electronic-, or mixed-mode).

Moreover, pedal-driven part 10 may include a plurality of gear plate 11 of various diameters. This design is known and used in the modern bicycles, so that it will not describe here further. However, it is worth to mention here that the functional wheel transmission gear disk 11 is formed by the designed gear plate 11 of plural concentric outer diameters, to form a set of various stall transformation with relay-gear 23, to enable the rider to proceed the stall transformation of gear plate 11, further to correspond to the stall transformation of transmission gear disc 31, in order to reach the effects of multi-stage speed change; Also, the controller (not shown in figure) can be the output signal, to be the speed adjustment of electric motor 21, to achieve the effects of variable-speed change and stop. The preferred embodiments and the best mode of carrying out the invention are intended to illustrate but not to limit the present invention. It will be apparent to one skilled in the art that various substitutions and modifications may be made to the invention disclosed herein without departing form the scope and the spirit of the invention. Accordingly, these substitutions, and modifications, and their legal equivalents are intended to be within the scope of present invention.

What is claimed is:

1. A dual-drivetrain for powering a vehicle by pedaling with an assistance of an electric motor, comprising:
a pedal-driven part, pivotally mounted to the frame of said vehicle, having at least one gear plate, a pair of cranks normally mounted 180 degree out of phase to said gear plate, and a pair of pedals pivotally attached to each of said cranks;
a motor-driven part, situated between said pedal-driven part and the real wheel of the vehicle, having a drive-gear being mechanically coupled to the real wheel of said vehicle, a relay-gear being attached to the armature of said electric motor, said relay-gear rotates only clockwise;
power conveying means having a gearing mechanism that is variable-ratio transmission system for selecting appropriate gear ratios during riding said vehicle and a first transmission member that couples said gear plate and said relay-gear for a synchronized rotation of said relay-relay and said pedal-driven part;
a controller, mounted of the frame, having a shifter for remotely operating said gearing mechanism and a regulator for regulating the rotational speed of said electric motor;
whereby, said controller outputs signals for adjusting vehicle speed; whereby driven by the pedals, the signals of sensor feed back to the controller, to control the electric motor-driven gear-driven operation, produce large torque output, to make the relay-gear and drive gear produce synchronous operation; and through the second pieces of transmission to make the functional wheel transmission gear disk to operate, and the relay-gear dose not need to operate; can directly use the pedals to drive the relay-gear and the drive gear to have synchronous operation, through the second pieces of transmission to drive the functional wheel transmission gear disk to run; all can correspond to the transmission for controlling the second pieces of transmission in order to approach the functional wheel of transmission gear disk if different concentric outer diameters, as the stalls transformation, to satisfy the rider with various kinds of riding terrains, can exercise in terms of their own choice of mode of labor-saving or demand.

2. The dual-drivetrain of claim 1, wherein said gear plate includes a plurality of concentric gears that has various diameters.

3. The dual-drivetrain of claim 1, wherein said gearing mechanism is a derailleur mechanism.

4. The dual-drivetrain of claim 1, wherein said derailleur mechanism comprises a rear derailleur, a transmission gear disc, and a second transmission member, concentrically attaches to the real wheel of said vehicle, for rotational coupling said transmission gear disc.

5. The dual-drivetrain of claim 1, wherein said regulator, coupled to said electric motor, has a power-control mean for controlling the speed of said electric motor, and a sensor for regulating the rotational speed of said electric motor.

6. The dual-drivetrain of claim 2, wherein said power-control means is pulse-width modulation.

7. The dual-drivetrain of claim 2, wherein said sensor has a vehicle's speed monitor and a feedback loop that electrically couples said vehicle's speed monitor and provides feedback signal to said power-control means for adjusting motor's speed based on vehicle's speed.
